(19) United States
(12) Patent Application Publication
(10) Pub. No.: US 2006/0008567 A1
(43) Pub. Date: Jan. 12, 2006

(54) Low carbohydrate flour additive

(76) Inventors: Ali A. Elmusa, Leawood, KS (US); Charles A. Morris, Overland Park, KS (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/177,915

(22) Filed: Jul. 7, 2005

Related U.S. Application Data
(60) Provisional application No. 60/586,001, filed on Jul. 7, 2004.

(51) Int. Cl. A21D 10/00

(52) U.S. Cl. 426/549

(57) ABSTRACT

A low-carbohydrate, high-fiber flour substitute is provided. The flour substitute can be added to a bread recipe as a replacement for flour, yielding a flavorful bread product that is highly processable under commercial bread product manufacturing conditions.

### CROSS-REFERENCE TO RELATED APPLICATIONS

This application claims the benefit of U.S. provisional patent application Ser. No. 60/586,001 filed Jul. 7, 2004, which is incorporated in its entirety by reference herein. This application relates to U.S. patent application Ser. No. ______ entitled “Dehydrated Edible Beans in Bread” filed Jul. 1, 2005, which claims the benefit of U.S. provisional application No. 60/585,394 filed Jul. 2, 2004, and this application relates to U.S. patent application Ser. No. ______ entitled “Low Carbohydrate Bread Product” filed ______, which claims the benefit of U.S. provisional patent application Ser. No. 60/587,221 filed Jul. 12, 2004, all of which are incorporated in their entirety by reference herein.

### FIELD OF THE INVENTION

A low carbohydrate, processable flour product is provided.

### BACKGROUND

Bread is produced commercially in batches using a variety of standard, commercially available devices. In commercial breadmaking processes, flour, water, yeast and any other desired ingredients are mixed, kneaded, and proofed. This process is performed in large batches that eventually are divided into multiple loaves of bread or other bread products. Machinery used in transferring and dividing batches of proofed dough includes dough pumps and “chunkers.” These devices have tolerances as to the rheology and elasticity of the types of dough that can be processed.

In preparation of low carbohydrate doughs, a portion of the flour is replaced with ingredients, such as wheat gluten and soy protein isolates. Wheat gluten is an elastic, proteinaceous component of bread flour and breads that gives the bread sufficient cohesiveness to rise and maintain its shape. Addition of isolated wheat gluten to bread dough in place of flour permits the dough to maintain its cohesiveness during proofing. However, addition of too much gluten yields an unworkable dough mass that cannot be processed by conventional dough pumps and chunkers. Use of soy protein isolate adds protein and insoluble fiber to the dough, but does not contribute to the cohesiveness of bread dough because it lacks gluten.

Dough relaxers, often referred as dough conditioners or mix reducers, can be used to counter the effects of wheat gluten. Dough relaxers can be chemical in nature, such as L-cysteine and sulfites, or enzymatic in nature, such as diastatic malt extract and Fermaid® products (Lallemand, Inc., Rexdale, Ontario). Despite the effectiveness of certain dough relaxers, their effectiveness is variable and determining effective combinations of relaxers and other ingredients is a time-consuming research project.

### SUMMARY

A bread dough mix additive is therefore provided that can be used to supplement flour in bread products. This additive is useful for increasing the protein and insoluble fiber content of bread dough, as well as yielding a dough product that is highly workable in commercial settings. The additive can be used as a substitute for all or part of the flour content in a large variety of formulae.

In one embodiment, a dough additive is provided, comprising wheat gluten, insoluble fiber and a dough conditioner comprising an oxidizer and a mix reducer.

One formulation includes from 50% wt. to 70% wt. wheat gluten, from 30% wt. to 40% wt. fiber, less than 1% oxidizer and from 2.0% wt. to 3.0% wt. mix reducer.

A dry bread dough mix also is provided, which comprises flour and the above-described additive of the invention in an amount ranging from 50% wt. to 150% wt. of the flour.

A bread dough is provided which comprises flour, a leavening agent, water and the above-described additive of the invention in an amount ranging from 50% wt. to 150% wt. of the flour.

A method of preparing a dough also is provided which comprises mixing flour, a leavening agent, water and the above-described additive of the invention in an amount ranging from 50% wt. to 150% wt. of the flour. The dough can be prepared by any method know in the art, including, without limitation, the straight dough method and the sponge method.

It should be understood that this invention is not limited to the embodiments disclosed in this summary, but it is intended to cover modifications that are within the spirit and scope of the invention, as defined in the claims.

### DETAILED DESCRIPTION

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. As such, it is to be understood that the description set forth herein is merely exemplary to the present invention and is not intended to limit the scope of the claims.

Furthermore, certain compositions within the present invention are generally described in the form of ingredients that may be used to produce certain doughs and bread products derived therefrom. It will be understood, however, that the present invention may be embodied in forms and applied to end uses that are not specifically and expressly described herein. For example, one skilled in the art will appreciate that embodiments of the present invention may be incorporated into any food.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and claims may be read as if prefaced by the word “about” even though the term “about” may not expressly appear with the value, amount, or range. Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total mass weight. When Baker's percentage is used herein, the values are relative to the flour content, i.e., flour comprises 100% of the composition and all the other ingredients are calculated in proportion to the weight of flour; thus, the percentage of the ingredient equals (the weight of ingredient divided by weight of total flour) multiplied by 100. Those of skill in the art recognize that percent mass weight, actual mass weight, and Baker's percentage are all interconvertable.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. The articles “a,” “an,” and “the” are used herein to refer to one or more than one (i.e., to at least one) of the grammatical object of the article. By way of example, “an element” means one or more elements, and thus, possibly, more than one element is contemplated, and may be employed or used.

Additives of the invention are described herein and are used in a bread dough as a substitute for flour. Additives can be used at a 1:1 ratio with flour, or any other appropriate ratio. The additives decrease the net carb value of the bread dough, while increasing the fiber and protein content of the product. As discussed above, adding substantial amounts of wheat gluten to a dough usually results in a dough that is unworkable in common industrial breadmaking processes. Use of the additive described herein results in a workable dough useful in a large variety of bread doughs. Additives of the invention can substitute for all or a part of the flour content of the bread dough.

As used herein, “bread dough” means a dough useful in preparation of bread products. Such products can be prepared by adding gluten and leavening the product with either yeast or a chemical leavener, such as baking soda or baking powder. Non-limiting examples of baked goods prepared with bread dough include: bread, buns, doughnuts, muffins, rolls, crackers, pitas, muffins, biscuits, pizza shells, pizza crusts, bagels, cookies, brownies, pancakes, pastas, tortillas, cereals, sheeted snacks, frozen doughs, and various other baked and processed foods.

Flour is ground and processed wheat prepared according to well-established commercial standards, often having a protein component of 8-12.5% by weight (% wt.) and includes, for example, wheat flour such as hard red spring flour, hard red winter wheat, soft red winter wheat, soft white winter wheat, chlorinated hard wheat straight flour, non-chlorinated patent flour, bread flour, whole wheat flour, all purpose flour and durum wheat, mixtures thereof, and the like. The term “high gluten flour” refers to commercial flour that has 14% protein or greater, such as for example, Gigantic High Gluten Flour® (ADM, Decatur, Ill.). Common commercial bread flour has approximately 12% protein.

Wheat gluten is extracted from flour and is often used as an additive in doughs and bread products derived therefrom. As used herein, “wheat gluten” refers to a protein extract of wheat flour. Wheat gluten is available in a range of protein contents, and can range in protein content from above 70% wt. from above 80% wt. or higher.

A mix reducer is a bread ingredient that facilitates mixing of the bread dough. Mix reducers, such as L-cysteine and glutathione, break disulfide bonds between the gluten strands in the formation of bread dough. Non-limiting examples of mix reducers include L-glycine; L-cysteine (e.g., added at 0.02% wt other suitable concentration); glutathione; non-leavening yeast (a source of glutathione; e.g., added from 2.0% wt. to 3.0% wt, for example 2.4%); bisulfite salts, such as sodium metabisulfite; sorbic acid (e.g., added at 0.02%, 0.2%, 0.5% wt., etc.); and enzymes, such as fungal proteases; as well as combinations thereof. For example, the mix reducer may comprise a combination of L-glycine, glutathione and non-leavening yeast. The mix reducer may also comprise a combination of L-glycine, non-leavening yeast, and sorbic acid. The mix reducer may also comprise a combination of xylanase, non-leavening yeast and sorbic acid. Mix reducers and combinations of mix reducers can be added at 0.5% to 4% weight, e.g., 0.5%, 1%, 2%, 3%, 4% wt. or more depending on the desired effect on the dough.

Oxidizers serve the opposite purpose of mix reducers and can consequently help strengthen dough structure. They may be selected to act more slowly than the mix reducers, so that the bread dough is initially more workable, but can recover from the mixing process and subsequent handling and proofing to reach a desired strength. Non-limiting examples of oxidizers include ascorbic acid, azido-carbamide, potassium or calcium bromate, and potassium or calcium iodate. Oxidizers can be added at 0.02% to 4% weight, e.g., 0.02%, 0.5%, 1%, 2%, 3%, 4% wt. or more depending on the desired effect on the dough.

Emulsifiers or surfactants increase the shelf-life of the breads and impart softness and tenderness. They also assist in strengthening the dough and helping the dough to retain its shape. Non-limiting examples of emulsifiers or surfactants include sodium stearoyl lactate, monoglycerides, diglycerides, ethoxylated monoglycerides, ethoxylated diglycerides, diacetyl tartate esters of fatty acids (DATEM), polyoxyethylene monoglycerides and succinyl monoglycerides, and combinations thereof.

“Insoluble fiber” refers to insoluble dietary fiber. Non-limiting examples of insoluble fiber include cellulose, alpha cellulose, and fiber derived from cereal grains, such as oat, wheat, corn, soy fiber, and combinations thereof. Insoluble fiber speeds the passage of foods through the stomach and intestines, and it adds bulk to the stool. It is found in foods such as wheat bran, vegetables, and whole grains. U.S. Pat. No. 5,976,598 provides non-limiting examples of cellulosic flour replacements useful as insoluble fiber in the methods described herein.

As used herein, “net carb” is calculated by subtracting the grams of fiber and sugar alcohols from the total carbohydrates in a food sample. The term “low carbohydrate” (abbreviated as “low carb”) refers to a food having a relatively low carbohydrate content (either total or net) compared to other foods or even the same foods but made using traditional formulas. Low carbohydrate foods include, for example, a dough or bread product derived therefrom that has a reduced carbohydrate content.

As used herein, “reduced carbohydrate” refers to dough, and bread products derived therefrom, comprising an ingredient of the invention wherein the carbohydrate content of the dough or bread products derived therefrom is less than that of the same dough or bread product of the same mass but made without the addition of the composition of the invention, and thus includes where the composition of the invention has been substituted for all or part of the flour content.

As used herein, “increased protein” refers to dough, and bread products derived therefrom, comprising an ingredient of the invention wherein the protein content of the dough or bread products derived therefrom is greater than that of the same dough or bread product of the same mass but made without the addition of the composition of the invention, and thus includes where the composition of the invention has been substituted for all or part of the flour content.

As used herein, “increased fiber” refers to dough, and bread products derived therefrom, comprising an ingredient of the invention wherein the fiber content of the dough or bread products derived therefrom is greater than that of the same dough or bread product of the same mass but made without the addition of the composition of the invention, and thus includes where the composition of the invention has been substituted for all or part of the flour content.

Additives of the invention described herein, in the most general form, comprises wheat gluten, insoluble fiber, and a dough conditioner that comprises an oxidizer and a mix reducer. The wheat gluten may comprise at least 75% wt. protein, that is, it has a protein content of at least 75% wt. However, the wheat gluten, may also have a higher protein content, such as at least 80% wt., e.g., 82% wt.

The dough additive contains between 50% wt. to 70% wt. wheat gluten though ranges from 33% wt. to 38% wt. (e.g., 36% wt.), from 55% wt. to 65% wt., from 58% wt. to 62% wt., and 60% may be used, depending on the final desired composition of the additive. In some embodiments, the dough additive can comprise Prolite 100™ (ADM, Keokuk, Iowa) having from 85% wt. to 90% wt. gluten.

Dough conditioners, such as mix reducers, oxidizers and emulsifiers or surfactants may be included in the additive of the invention to further enhance the workability of the dough. The additives may include less than 3.0% wt., and more than 1.0% wt. of mix reducers. In certain instances, additional mix reducer may be added. For example, in one embodiment, sorbic acid, L-cysteine, and glutathione (in the form of non-leavened yeast) are combined to form the mix reducer of the additive. In many instances, a single mix reducer cannot relax the bread dough sufficiently. Further, the maximum permissible levels of some mix reducers, such as L-cysteine, are set by government regulatory agencies. Additionally, different mix reducers, as with any ingredient, impart their characteristic flavor, odor, and organoleptic qualities on the finished product. Thus, in one embodiment, the combination of sorbic acid, L-cysteine, and glutathione does not negatively affect the flavor, odor, and organoleptic qualities of the end-product. Other combinations of mix reducers may be also be used to relax the dough during mixing, handling and shaping. Determining such a combination is well within the abilities of one of ordinary skill in the breadmaking art.

One or more oxidizers may also be included in the additive to counteract the reducing effect of the mix reducer and the stress on the dough caused by the dough processing machinery. In some embodiments, the additive contains less than 1% oxidizer. The amount of oxidizer can vary, depending upon the choice of oxidizer. Ascorbic acid, an oxidizer under aerobic conditions, may used effectively at 0.02% wt. and above. As with the mix reducers, oxidizers may be used effectively, alone or in combination, with another oxidizer and determining which oxidizer or combination of oxidizers to use is well within the abilities of one of ordinary skill in the breadmaking art.

Emulsifiers or surfactants may be used to improve the dough and end product and may be included in the additive of the invention. For example, the amount of emulsifiers to be included in the additive may range from 1% wt. to 2% wt. As with the mix reducers and oxidizers, each emulsifier or surfactant imparts distinct flavors, odors, and organoleptic qualities to a bread product and, further, adds to the structure of the bread product in distinct ways, as are known to those of ordinary skill in the art. Emulsifiers or surfactants may be included in the additive alone or in combination. As shown in the examples, the combination of sodium stearoyl lactate at 0.5% wt. and a mixture of ethoxylated and non-ethoxylated mono- and diglycerides at 1% wt) may be used alone or in combination as part of the additive of the invention.

Bread doughs can be prepared by standard formulae with the additive replacing major portions of the flour component of the bread dough. The additive can be added to the bread dough in amounts ranging from less than 1% up to and even greater than 150% (Baker's percentage) of the flour content of the bread dough. Other ingredients in the bread dough may include, without limitation: a leavening agent, such as yeast; multigrain mix (an additive including products derived from, without limitation: amaranth, barley, buckwheat, corn, flax, legumes, pulses, millet, oats, oilseeds, rice, rye, spelt, sunflower, triticale and wheat; including, without limitation, granola, flax seeds, sunflower seeds, bran and grits and 20% wheat flour as carrier, though the amount of wheat flour may vary, depending on the source and desired composition), baking powder and baking soda; sweeteners, such as sugar, high fructose corn syrup, polyols and other artificial sweeteners, molasses and honey (liquid or dried); yeast foods (including for example ADM KC Yeast Food™ (e.g., 3.9% of the mix reducer) (ADM Arkady, Olathe KS), Red Star® yeast food (e.g., 3.9% of the mix reducer), and Red Star 190® yeast, (e.g., 2%, 1.6%, 1.35%, and from 1.6% to 1.8% of the mix reducer) (Red Star, Milwaukee, Wis.)); whole wheat flour; multigrain flour; corn flour; additional wheat gluten; shortening; salt, baking powder; baking soda; and protein isolate, such as soy protein isolate and wheat protein isolate. Additional ingredients, such as, without limitation: nuts, dried fruits, whole grains, spices, and seasonings also may be added to the dough.

In one embodiment, the bread dough comprises from 16 Baker's percent to 100 Baker's percent wheat gluten (including wheat gluten provided by the additive). In yet other embodiments, the bread dough comprises from 40 Baker's percent to 100 Baker's percent wheat gluten, or from 50 Baker's percent to 100 Baker's percent wheat gluten, or in some embodiments from 75 Baker's percent to 100 Baker's percent wheat gluten, all of which include the wheat gluten provided by the additive. Those of skill in the art recognize that gluten levels such as those recited herein can be considered surprisingly high for a processable dough.

As described herein, the additive of the invention may be used as a substitute for part of the flour component of a dough or bread product formula, such as 50 to 100% weight, (abbreviated herein as “wt.”). In some embodiments of the invention, the additive may comprise 70 Baker's percent to 90 Baker's percent of a dough (e.g., 80 Baker's percent). In some embodiments, 50% of more of the flour by weight may be removed by weight and replaced with 104% (Baker's percent) of the additive based on the remaining flour content (e.g. the additive is Reduced carb mix 113-675™ (ADM Arkady, Olathe KS)). In some other embodiments, 50% or more of the flour may be removed by weight and replaced with 75% (Baker's percent) of the additive of the present invention based on the remaining flour content (e.g. where the additive is reduced carb mix 113-611 ™ (ADM Arkady, Olathe KS), and with 28% (Baker percent) of vital wheat gluten™ (ADM Arkady, Olathe KS).

In some embodiments, the dough additive comprises 60% wt. of wheat gluten; 36% wt. of an alpha cellulose; 2.4% wt. of a non-leavening yeast; 1% wt. of one or more of monoglycerides, diglycerides, ethoxylated monoglycerides and ethoxylated diglycerides; 0.48% wt. sorbic acid; 0.48% of sodium stearoyl lactate; 0.19% wt. of ascorbic acid; and 0.17% wt. of L-cysteine. In yet other embodiments, a dough comprising the additives of the invention is prepared with 100 Baker's percent of whole wheat flour, 16 Baker's percent of wheat gluten, 1.5 Baker's percent of a protease mix reducer, water, 80 Baker's percent of the additive of the present invention, 4 Baker's percent of dry yeast, 10 Baker's percent of shortening, 8 Baker's percent of high fructose corn syrup, 3 Baker's percent honey and 5 Baker's percent of salt. In some embodiments comprising the additives of the present invention, the dough is prepared with 40 Baker's percent white bread flour, 60 Baker's percent multi-grain mix, 16 Baker's percent wheat gluten, water, 11 Baker's percent compressed yeast, 0.5 Baker's percent yeast food, 10 Baker's percent shortening, 80 Baker's percent of the additives of the invention, 7 Baker's percent of one of sugar and high fructose corn syrup, 3 Baker's percent molasses, 3 Baker's percent honey, and 4 Baker's percent salt. In yet other embodiments, a dough comprising the additives of the invention is prepared with 40 Baker's percent whole wheat flour, 60 Baker's percent multi-grain mix, 16 Baker's percent wheat gluten, 1 Baker's percent of a protease mix reducer, water, 12.8 Baker's percent cream yeast, 10 Baker's percent shortening, 7 Baker's percent high fructose corn syrup, 3 Baker's percent molasses, 3 Baker's percent honey, and 5 Baker's percent salt.

There are two primary, well-established commercial breadmaking processes, the sponge method and the straight dough method. In the straight dough method, all ingredients are mixed essentially at once, the dough is proofed and baked. In the sponge method, flour, yeast and yeast food are mixed into a sponge and fermented before the dough is formed with the addition of flour, and, in the present case, the dough additive.

The following are examples of compositions of the invention, including, for example, tortillas, bread, buns, pizza dough and bagels. The examples are not meant to limit the scope of the invention, as defined by the claims.

### EXAMPLE 1

### Reduced Carbohydrate Flour Substitute

A Reduced Carbohydrate Flour Substitute also referred to herein as “additive” was prepared by standard blending methods. As a first step, a pre-mix was prepared including the following ingredients in Table 1 (percentages are weight percentages of the final flour substitute):

TABLE 1

| Ingredient | % wt. |
|---|---|
| Wheat Gluten (82.3% protein) | 50.00% |
| Sorbic Acid | 24.20% |
| Sodium Stearoyl Lactate | 24.00% |
| Ascorbic Acid | 0.95% |
| L-Cysteine Powder | 0.85% |

The following ingredients in Table 2 were then added to the pre-mix:

TABLE 2

| Ingredient | % wt. |
|---|---|
| Wheat Gluten (82.3% protein) | 58.78% |
| Alpha Cellulose Fiber (BH-200 ™) ADM, Decatur, IL) | 35.88% |
| Bakezyme RX ® (Glutathione) (DSM, Delft, the Netherlands) | 2.39% |
| TALLY 100+ ™ (a mixture of monoglycerides, | 0.95% |
| diglycerides, ethoxylated monoglycerides and ethoxylated | |
| diglycerides, commercially available | |
| from ADM Specialty Food Ingredients, Decatur, IL) | |
| Reduced Carb Premix (Table 1) | 2.00% |

### EXAMPLE 2

### Reduced Carbohydrate White Bread

This formula provides reduced carbohydrates in a white pan type bread. The formula provides 9.4 grams of carbohydrate in a 28-gram serving. The carbohydrates are reduced 30% by use of the Flour Substitute of Example 1 when compared to commercially prepared white bread that has 14 grams per 28-gram serving. The reduced carbohydrate bread has 20% less calories than white bread. Net carb is 4.6 grams per 28-gram serving.

A sponge was prepared by mixing the following ingredients (unless otherwise indicated, all percentages in Examples 2-10 are Baker's percent, that is, in reference to the total flour content of the complete dough being 100%: flour (12.5% protein), 70%; water, 32% (of total water); yeast, compressed, 3.3%; KC Yeast Food™, no bromate (ADM Arkady), 0.5%; and Provim ESP® wheat gluten sold by ADM, Decatur, Ill. (75% protein) 28%. The sponge was mixed two minutes low speed and seven minutes high speed at 24° C. The sponge was fermented at 23° C.-25° C. and 80% RH for three to four hours.

Dough was prepared by adding to the sponge: flour (11.5% protein) 30%; sugar, 5.5%; compressed yeast, 1%; water, 68% (of total water); Reduced Carbohydrate Flour Substitute of Example 1, 104%; and salt, 4.4%, with total water, 287%. The flour was prepared according to the following:
1. Mix to gluten development with a dough temperature at 27° C.
2. Floor time 10-15 minutes.
3. Shape and pan, 510 g for 454 g loaf.
4. Proof, 41° C.-43° C. for 60 minutes.
5. Bake at 218° C.-221° C. for 18-22 minutes.

The product prepared according to this method contains the following in a serving size of 28 g: 51 calories; 0.4 g total fat, with no saturated fat and no cholesterol; 9.4 g total carbohydrate, with 4.7 g insoluble fiber and 0.1 g sugars; and 5.8 g protein.

### EXAMPLE 3

### Honey Wheat Bread

This formula provides reduced carbohydrates in a honey wheat type hamburger bun or bread. The formula will provide 15.4 grams of carbohydrate in a 51-gram serving. The carbohydrates are reduced 47% by use of the Flour Substitute of Example 1 when compared to commercially prepared white bread that has 29.5 grams per 51-gram serving. Net carb is 9.5 grams per 51 gram serving or 5.2 grams net carb in a 28-gram serving.

A sponge was prepared by mixing the following ingredients: whole wheat flour (12.5% protein), 90%; water, 78%; dry yeast 4%; all purpose shortening, 10%; KC Yeast Food No Bromate™, 0.75%; Provim ESP® wheat gluten, 16.0%; and 2× MLO (a fungal protease mix reducer commercially available from ADM Specialty Food Ingredients of Decatur, Ill.) at 1.5%. The sponge was prepared according to the following:
1. Mix 2 minutes low speed and 7 minutes high speed with dough temperature 24° C.-26° C.
2. Fermentation 23° C.-25° C. and 80% RH for 3 to 4 hours.

Dough was prepared by adding to the sponge: whole wheat flour (11.5% protein) 10%; water, 67%; Reduced Carbohydrate Flour Substitute of Example 1, 80%; High Fructose Corn Syrup, 8%; honey, 3%; and salt, 5% with total water being 208% based on flour. The dough was processed according to the following:
1. Mix to gluten development with a dough temperature 27° C.
2. Floor time 5-10 minutes.
3. Scale and pan at 60 grams.
4. Proof, 41° C.-43° C. for 60 minutes.
5. Bake at 218° C.-221° C. for 18-22 minutes.

The product prepared according to this method contains the following in a serving size of 51 g: 118 calories; 1.9 g total fat, with no saturated fat and no cholesterol; 15.4 g total carbohydrate, with 5.9 g insoluble fiber and 0.2 g sugars; and 9.4 g protein.

### EXAMPLE 4

### Multigrain Bun, Straight Dough Method

This formula provides reduced carbohydrates in a multigrain type bun. The formula will provide 21.9 grams of carbohydrate in a 76-gram serving. The carbohydrates are reduced 49% by use of the Flour Substitute of Example 1 when compared to commercially prepared white bread that has 43.9 grams per 76-gram serving. Net carb is 8 grams per 76-gram serving.

Dough was prepared using the following ingredients: white bread flour (12.5% protein), 40%; multigrain mix (commercially available from ADM Specialty Food Ingredients), 60%; water, 180%; compressed yeast, 11%; KC Yeast Food No Bromate™, 0.5%; Provim ESP® wheat gluten, 16%; all purpose shortening, 10%; Reduced Carbohydrate Flour Substitute of Example 1, 80%; sugar or Cornsweet 42 High Fructose Corn Syrup, 7%; light liquid molasses, 3%; liquid honey, 3%; and salt, 4%. The dough was prepared according to the following procedure:
1. Mix to gluten development; mix 2 minutes low, 11 minutes high with dough temperature 27° C.
2. Floortime 5-10 minutes.
3. Shape and pan, 64 g.
4. Proof, 41° C.-43° C. for 60 minutes or less.
5. Bake at 216° C. for 12 minutes.

The product prepared according to this method contains the following in a serving size of 76 g: 156 calories; 2.8 g total fat, with no saturated fat and no cholesterol; 21.9 g total carbohydrate, with 13.8 g insoluble fiber and 0.2 g sugars; and 14.4 g protein.

### EXAMPLE 5

### Multigrain Whole Wheat Bread

This formula provides reduced carbohydrates in a multigrain whole wheat type hamburger bun or bread. The formula provides 14.7 grams of carbohydrate in a 51-gram serving. The carbohydrates are reduced 49% by use of the Flour Substitute of Example 1 when compared to commercially prepared white bread that has 29.5 grams per 51-gram serving. Net carb is 5.7 grams per 51 gram serving or 3.2 grams net carb in 28-gram serving.

A sponge was prepared using the following ingredients: whole wheat flour (12.5% protein), 30%; multigrain mix 60%; water, 78.8% (of total water); cream yeast, 12.8%; KC Yeast Food No Bromate™, 0.75%; Provim ESP® wheat gluten, 16%; 2× MLO 1.5%. The sponge was processed according to the following:
1. Mix 2 minutes low speed; 7 minutes high speed with dough temperature 24° C.-26° C.
2. Fermentation 23° C.-25° C. and 80% RH for three to four hours.

Dough was prepared by adding to the sponge the following ingredients: whole wheat flour (11.5% protein), 10%; all purpose shortening, 10%; water 140% (of total water); Reduced Carbohydrate Flour Substitute of Example 1, 80%; Cornsweet 42 High Fructose Corn Syrup, 7%; light liquid molasses, 3%; liquid honey, 3%; salt, 5%, with the total water being 219% based on flour. Bread was prepared according to the following process:
1. Mix to gluten development with dough temperature 27° C.
2. Floor time 5-10 minutes.
3. Scale and pan at 60 grams for 51-gram buns.
4. Proof, 41° C.-43° C. for 60 minutes.
5. Bake at 218° C.-221° C. for 18-22 minutes.

The product prepared according to this method contains the following in a serving size of 51 g: 115 calories; 1.9 g total fat, with no saturated fat and no cholesterol; 14.7 g total carbohydrate, with 9.0 g insoluble fiber and 0.2 g sugars; and 9.7 g protein.

### EXAMPLE 6

### White Rolls, Straight Dough Method

This formula provides reduced carbohydrates in a white hamburger bun. The formula will provide 16.6 grams of carbohydrate in a 51-gram serving. The carbohydrates are reduced 43% using the Flour Substitute of Example 1 when compared to a commercially prepared white hamburger bun that has 29.5 grams per 51-gram serving. Net carb is 12.6 grams per 51-gram serving.

The dough was prepared with the following ingredients: flour (12.5% protein), 100%; Provim ESP® Wheat Gluten, 30%; dry yeast, 3%; all purpose shortening, 9%; sugar, 6%; salt, 5%; KC Yeast Food No Bromate™, 1.5%; Reduced Carbohydrate Flour Substitute of Example 1, 104%; water, 233%. Rolls were prepared according to the following process:
1. Mix to full gluten development (do not over mix) with dough temperature 28° C.-29° C.
2. Floor time: 10 minutes
3. Scale and pan at 60 grams for 51-gram buns.
4. Proof: 50-60 minutes
5. Bake at 204° C. for 18-20 minutes.

The product prepared according to this method contains the following in a serving size of 51 g: 108 calories; 1.7 g total fat, with no saturated fat and no cholesterol; 16.6 g total carbohydrate, with 4.0 g insoluble fiber and 0.7 g sugars; and 10.5 g protein.

### EXAMPLE 7

### White Hamburger Bun

This formula provides a white hamburger bun with reduced carbohydrates. The formula provides 16.6 grams of carbohydrate in a 51-gram serving. The carbohydrates are reduced 43% using the Reduced Carbohydrate Flour Substitute of Example 1 when compared to a commercially prepared white hamburger bun that has 29.5 grams per 51-gram serving. Net carb is 12.6 grams per 51-gram serving.

A sponge was prepared from the following ingredients: flour (12.5% protein), 80%; water, 36% (of total water); all purpose shortening, 9%; dry yeast, 3.25%; 2× MLO 2.0%; KC Yeast Food No Bromate™, 0.5%; and Provim ESP® wheat gluten, 30%. The sponge was prepared according to the following procedure:
1. Mix 2 minutes low speed; 7 minutes high speed with dough temperature 24° C.
2. Fermentation 23° C.-25° C. and 80% RH for 3 to 4 hours.

Dough was prepared by adding the following ingredients to the sponge: flour (11.5% protein), 20%; sugar, 6.25%; water, 64% (of total water); Reduced Carbohydrate Flour Substitute of Example 1, 104%; and salt, 5%, where the total water in the formula is 243% based on flour. The hamburger buns were prepared by the following method:
1. Mix to gluten development with a dough temperature 27° C.
2. Floor time 5-10 minutes.
3. Shape and pan, 64 g.
4. Proof, 41° C.-43° C. for 60 minutes.
5. Bake at 216° C. for 12 minutes.

The product prepared according to this method contains the following in a serving size of 51 g: 108 calories; 1.7 g total fat, with no saturated fat and no cholesterol; 16.6 g total carbohydrate, with 4.0 g insoluble fiber and 0.7 g sugars; and 10.5 g protein.

### EXAMPLE 8

### Whole Wheat Hamburger Bun

This formula provides reduced carbohydrates in a whole wheat type hamburger bun. The formula will provide 14.9 grams of carbohydrate in a 51-gram serving. The carbohydrates are reduced 49% using the Reduced Carbohydrate Flour Substitute of Example 1 when compared to commercially prepared white bread that has 29.5 grams per 51-gram serving. Net carb is 10.3 grams per 51-gram serving.

A sponge was prepared using the following ingredients: whole wheat flour (12.5% protein), 90%; water, 35% (of total water); dry yeast, 4%; all purpose shortening, 10%; KC Yeast Food No Bromate™, 0.75%; Provim ESP® wheat gluten, 35%; 2× MLO, 1.5%. The sponge was prepared according to the following procedure:
1. Mix 2 minutes low speed and 7 minutes high speed with dough temperature 24° C.-26° C.
2. Fermentation 23° C.-25° C. and 80% RH for 3 to 4 hours.

Dough was prepared by adding to the sponge the following ingredients: whole wheat flour (11.5% protein), 10%; water, 67% (of total water); Reduced Carbohydrate Flour Substitute of Example 1, 121%; Cornsweet 42 High Fructose Corn Syrup, 9%; light liquid molasses, 3%; and salt, 5.5%, where the total water is 310% based on flour. The hamburger buns were prepared according to the following procedure:
1. Mix to gluten development with a dough temperature 27° C.
3. Floor time 5-10 minutes.
4. Shape and pan, 64 g.
5. Proof, 41° C.-43° C. for 60 minutes or less.
6. Bake at 216° C. for 12 minutes.

The product prepared according to this method contains the following in a serving size of 51 g: 105 calories; 1.8 g total fat, with no saturated fat and no cholesterol; 14.9 g total carbohydrate, with 4.6 g insoluble fiber and 0.2 g sugars; and 11.0 g protein.

### EXAMPLE 9

### Pizza Dough

This formula has reduced carbohydrates in white bread pizza dough. The formula will provide 9 grams of carbohydrate in a 28-gram serving. The carbohydrates are reduced 35% using the Reduced Carbohydrate Flour Substitute of Example 1 when compared to commercially prepared pizza dough that has 14 grams per 28-gram serving. Net carbs 4.7 grams per 28 gram serving.

The dough is prepared according to a straight dough procedure. The dough includes the following ingredients: flour (11.5-12.5% protein), 100%; water 210-230%; dry yeast, 3%; sugar, 6.25%; KC Yeast Food No Bromate™, 0.5%; shortening, 6.25%; Provim ESP® Wheat Gluten, 25%; Reduced Carbohydrate Flour Substitute of Example 1, 100%; baking powder, 3%; and salt, 4%. The dough is prepared according to the following procedure:
1. Mix 2 minutes low and 10 minutes high speed with a dough temperature of 19° C.
2. Fermentation: 5-10 minutes.
3. Form into round.
4. Rest time: 10 minutes.
5. Sheet.
6. Bake at 218° C.

The pizza dough can be frozen immediately prior to fermentation (step 3), thawed in a refrigerator (4° C.) and subsequently formed into a round according to the above-described process. Alternately, the round of step 4 can be frozen and later thawed in a refrigerator.

The product prepared according to this method contains the following in a serving size of 28 g: 67 calories; 1.0 g total fat, with no saturated fat and no cholesterol; 9.0 g total carbohydrate, with 4.3 g insoluble fiber and 0.1 g sugars; and 5.6 g protein.

### EXAMPLE 10

### Multigrain Pizza Dough

This formula has reduced carbohydrates in a multigrain pizza dough. The formula will provide 8 grams of carbohydrate in a 28-gram serving. The carbohydrates are reduced 57% using Reduced Carbohydrate Flour Substitute of Example 1 when compared to commercially prepared bread that has 14 grams per 28-gram serving. Net carbs 4 grams per 28-gram serving.

The pizza dough is prepared from the following ingredients: whole wheat flour, 100%; water, 190%; dry yeast, 5.2%; sugar, 8%; KC Yeast Food No Bromate™, 0.5%; shortening, 12%; Reduced Carbohydrate Flour Substitute of Example 1, 80%; ADM Protein Isolate #2 (hydrolyzed wheat gluten) (item 001500) Prolite® 200 (ADM, Keokuk, IA), 4%; baking powder, 3%; Sweet'n'Neat® 2000 Dry Honey, 3%; Sweet'n'Neat® 4000 Dry Molasses, 2%; and salt, 4.8%. The dough was prepared according to the following procedure:
1. Mix 2 minutes low and 10 minutes high speed with a dough temperature of 19° C.
2. Fermentation: 5-10 minutes.
3. Form into round.
4. Rest time: 10 minutes.
5. Sheet.
6. Bake at 218° C.

The product prepared according to this method contains the following in a serving size of 28 g: 50 calories; 1 g total fat, with no saturated fat and no cholesterol; 8 g total carbohydrate, with 4.3 g insoluble fiber and 0.1 g sugars; and 4 g protein.

### EXAMPLE 11

### Low Carbohydrate Mix Reducer

A reduced carbohydrate flour substitute, also referred to herein as “additive”, was prepared by standard blending methods. As a first step, a pre-mix was prepared including the ingredients as shown in Table 3 (percentages are weight percentages of the pre-mix). The use level of the mix reducer was 2-4% by dry ingredients.

TABLE 3

| | Percent |
|---|---|
| Ingredient | Weight |
| Prolite ® 100 (Wheat Protein | 75.02 |
| isolate, Keokuk, IA) | |
| Dry Yeast (RS190 Lesaffre Yeast | 24.36 |
| Corp., Milwaukee, WI 53202) | |
| Sorbic acid | 0.5 |
| Xylanase (Bakezyme ® 5001, | .12 |
| DSM, Delft, The Netherlands) | |

### EXAMPLE 12

### Low Carbohydrate Bagels

Dough was prepared by combining the ingredients as shown in Table 4. The dough was prepared according to the following procedure.
1. Mix 1-minute low and 5 minutes high speed.
2. Temperature 28-30° C.
3. Scaling: 57-113 g balls.
4. Retarding time: (optional): 12-18 hours.
5. Retarding temperature: 2-6° C.
6. Proofing time: 35-45 minutes.
   Cook in boiling water one minute on each side.
   Bake 16 minutes at 218° C. with steam.

The product contained a total fat, fiber, protein, and carbohydrate content (total and net grams) as shown in Table 5.

TABLE 4

| | A | B |
|---|---|---|
| Ingredients | Grams | Grams |
| High gluten flour | 400 | 400 |
| Water | 540 | 600 |
| Bagel base | 48 | 48 |
| 113-611 Reduced carb mix ™ | 100 | 120 |
| (ADM, Arkady, Olathe, KS) | | |
| Shortening | 12 | 12 |
| Gluten | 40 | 45 |
| Profam 825 ™(ADM Keokuk IA) | 60 | 75 |
| Yeast | 8 | 8 |
| Oat fiber (Vitacell ®, JRS, | 50 | 50 |
| Rosenberg, Germany) | | |

TABLE 5
Content of 55-gram serving

| | |
|---|---|
| Carbohydrate | 21.3 g |
| Net Carb | 15.4 g |
| Fiber | 5.9 g |
| Protein | 8.9 g |
| Fat | 1.1 g |

### EXAMPLE 13

### Low Carbohydrate Pizza Dough

Dough was prepared by combining the ingredients as shown in Table 6. The dough was prepared according to the following procedure.
1. Mix 1-minute low speed and 5-6 minutes high speed.
2. Fermentation: 5-10 minutes.
3. Form into round
4. Rest time: 10 minutes.

5. Bake at 218° C. for 11 minutes (6A) or 12 minutes (6B)

TABLE 6

| | A | B |
|---|---|---|
| Ingredients | Grams | Grams |
| Flour | 400 | 400 |
| Water | 700 | 875 |
| Dry yeast | 14 | 12 |
| Sugar | 25 | 25 |
| KC Yeast Food 113-148 ™ | 2 | 2 |
| (ADM, Arkady, Olathe, KS) | | |
| Shortening | 25 | 25 |
| Gluten | 112 | 100 |
| 113-611 Reduced carb mix ™ | 300 | — |
| (ADM, Arkady, Olathe KS) | | |
| Baking powder | 16 | 12 |
| Salt | 16 | 16 |
| 113-675 Reduced carb mix ™ | — | 400 |
| (ADM, Arkady, Olathe KS) | | |

### EXAMPLE 14

### Low Carbohydrate White and Multigrain and Honey Wheat Buns

Dough was prepared by combining the ingredients as shown in Table 7 (sponge) and Table 8 (dough). The dough was prepared according to the procedure shown in Example 7. Mix times were 1 minute low, and 7 minutes high speed (7A, 8A) or 9 minutes high speed (7B, 8B) or 8 minutes (7C, 8C).

TABLE 7

| | A | | C |
|---|---|---|---|
| | Low | B | Honey |
| | carbohydrate | Multigrain | Wheat |
| Ingredients | White Buns | Buns | Buns |
| Sponge | Grams | Grams | Grams |
| Flour | 320 | — | — |
| Water | 330 | 197 | 197 |
| Yeast | 140 | 150 | 14 |
| Yeast Food | 2.25 | 1.88 | 1.88 |
| Gluten | 12.5 | 40 | 40 |
| Shortening | 25 | 25 | 25 |
| Multigrain Mix 113- | — | 150 | — |
| 633 ™ (ADM, | | | |
| Arkady, Olathe KS) | | | |
| Whole Wheat Flour | — | 75 | 225 |
| 2xMLO ® (ADM, | — | 3.75 | 3.75 |
| Arkady, Olathe KS) | | | |

TABLE 8

| | A | | C |
|---|---|---|---|
| | Low | B | Honey |
| | carbohydrate | Multigrain | Wheat |
| Ingredients | White Buns | Buns | Buns |
| Dough | Grams | Grams | Grams |
| Flour | 130 | — | — |
| Water | 570 | 340 | 340 |
| Sugar | 25 | — | — |
| High fructose corn | — | 25 | 25 |
| syrup (Cornsweet ® | | | |
| ADM, Decatur IL) | | | |
| Salt | 20 | 11 | 12 |
| Honey | — | 15 | 15 |
| Molasses | — | 7.5 | — |
| 113-611 Reduced | 340 | — | — |
| carb mix ™ (ADM | | | |
| Arkady, Olathe, KS) | | | |
| 113-675 Reduced | — | 200 | 200 |
| carb mix ™ (ADM | | | |
| Arkady, Olathe, KS) | | | |
| Whole Wheat Flour | — | 25 | 25 |

### EXAMPLE 15

### Multigrain Pizza

Dough was prepared by combining the ingredients shown in Table 9. The dough was prepared according to the method as described in Example 13.

TABLE 9

| | Baker's |
|---|---|
| Ingredients | Percent |
| Whole wheat flour | 100 |
| Multigrain Mix 113-633 ™ (ADM | 150 |
| Arkady, Olathe KS) | |
| Dry yeast | 13 |
| KG Yeast Food No Bromate 113- | 1.25 |
| 148 ™ (ADM Arkady, Olathe KS) | |
| Shortening | 30 |
| 113-675 Reduced carb mix (ADM | 200 |
| Arkady, Olathe KS) | |
| Dry honey | 7.5 |
| Dry molasses | 5 |
| Salt | 12 |
| Sugar | 20 |
| Water | 475 |
| 113-712 ADM Baking powder (ADM | 7.5 |
| Arkady, Olathe, KS) | |
| Prolite 200 ® (Protein isolate, | 12.5 |
| Keokuk, IA) | |

### EXAMPLE 16

### Low Carbohydrate Bagel

Dough was prepared by combining the ingredients shown in Table 10. The dough was prepared according to the method as described in Example 12.

TABLE 10

| Ingredients | Grams |
|---|---|
| High gluten flour | 400 |
| Water | 510 |
| Bagel base 113-223 | 42 |
| (ADM Arkady, Olathe, | |
| KS) | |
| Shortening | 12 |
| Dry yeast | 7 |
| 113-611 Reduced carb | — |
| mix ™ (ADM Arkady, | |
| Olathe KS) | |
| 113-675 Reduced carb | 200 |
| mix ™ (ADM Arkady, | |
| Olathe, KS) | |

### EXAMPLE 17

### Low Carbohydrate Mix Reducer

A reduced carbohydrate flour substitute, also referred to herein as “additive”, was prepared by standard blending methods. As a first step, a pre-mix was prepared including the ingredients as shown in Table 11 (percentages are weight percentages of the final flour substitute) to be added to formulae for bread and buns. A test of 4% pre-mix based on complete mix reduced mix time by 30-40%, although loaf quality was decremented. In some formulae, the level can be reduced to 2% of flour with the dry ingredients (i.e., 4% based on flour in the mix).

TABLE 11

| Ingredients | |
|---|---|
| Prolite 500 ™ (Protein Isolate, | 75.02 |
| ADM, Keokuk, IA) | |
| Deactivated yeast (Red Star | 24.36 |
| 190 ™, Red Star Corp. Milwaukee, | |
| WI) | |
| Sorbic acid | .5 |
| Bakezyme BXP 5000 (DSM, Delft, | .12 |
| The Netherlands) | |

### EXAMPLE 18

### Low Carbohydrate Tortillas

Dough was prepared by combining the ingredients shown in Table 12. The dough was prepared according to the following method.
1. Cream dry ingredients and shortening 3-5 minutes on low.
2. Add water and mix dough on slow speed. Temperature of dough should be 32-38° C.
3. Scaling: 57 g ball.
4. Rest time: 15 minutes.
5. Press and cook for 45-60 seconds.

All formulae produced useful bread products. It is contemplated that the water content of the formula shown in Table 12 A could be increased by 2% to further improve the bread product.

TABLE 12

| | A | B | C | D |
|---|---|---|---|---|
| Ingredients | Grams | Grams | Grams | Grams |
| Flour | 150 | 100 | 50 | — |
| Gluten | 60 | 60 | 60 | 80 |
| Oat fiber (Vitacel ™, | 50 | 50 | 50 | 65 |
| JRS, Posenberg, | | | | |
| Germany) | | | | |
| Prolite 100 ® (Wheat | 65 | 65 | 65 | 50 |
| protein isolate, ADM | | | | |
| Arkady, Olathe, KS) | | | | |
| ADM AZ Tortilla Base ™ | 30 | 30 | 28 | 28 |
| (ADM, Decatur IL) | | | | |
| Shortening | 40 | 40 | 45 | 40 |
| Water | 310 | 310 | 300 | 330 |
| Wheat starch | 50 | 100 | 150 | 200 |
| Fibersol 2 (Matsutani | 50 | 50 | 25 | 35 |
| America, Decatur IL) | | | | |
| ProFam 825(ADM, | — | — | — | — |
| Keokuk IA) | | | | |
| Locust Bean Gum | — | — | — | — |
| Fibersol 2(Matsutani | 50 | 50 | — | — |
| America, Decatur IL) | | | | |
| Bakezyme I (DSM, | — | — | — | — |
| Delft, The Netherlands | | | | |

### EXAMPLE 19

### Low Carbohydrate Mix Reducer

A reduced carbohydrate flour substitute, also referred to herein as “additive”, was prepared by standard blending methods. As a first step, a pre-mix was prepared including the ingredients as shown in Table 13 (percentages are weight percentages of the final flour substitute) to be added to formulae for bread and bread products. The test of 2% pre-mix was based on complete mix.

TABLE 13

| Ingredients | |
|---|---|
| Prolite 100 ™ (Protein | 75.02 |
| Isolate, ADM, Keokuk, | |
| KS) | |
| Yeast (Red Star 190 ™, | 24.36 |
| Red Star Corp. | |
| Milwaukee, WI | |
| Sorbic Acid | .5 |
| Bakezyme BXP 5000 BG | .12 |
| (DSM, Delft, The | |
| Netherlands) | |

### EXAMPLE 20

### Low Carbohydrate Raised Donuts

Dough was prepared by combining the ingredients shown in Table 14. The dough was prepared according to the following method:
1. Mix 1 minute low speed and 5 minutes high speed.
2. Rest time: 1 hr. in proof box and 20 minutes floor time
3. Sheet and cut.
4. Proof 30 to 35 minutes.

5. Bake 1 minute on each side.

TABLE 14

| Ingredients | A Grams |
|---|---|
| ADM donut mix (ADM, | 300 |
| Decatur, IL) | |
| Bread flour | 50 |
| 113-675 Reduced carb | 250 |
| mix ™ (ADM Arkady, | |
| Olathe, KS) | |
| Dry yeast | 12 |
| Water | 450 |

### EXAMPLE 21

### Low Carbohydrate Bagel

Dough was prepared by combining the ingredients shown in Table 15 using the methods as shown in Example 12. The formula yields 12 net carbs per 70-gram bagel. The product contained a total fat, fiber, protein, and carbohydrate (total and net grams) as shown in table 16.

TABLE 15

| Ingredients | Grams |
|---|---|
| High gluten flour | 300 |
| Water | 485 |
| Bagel base 113-223 ™ | 35 |
| (ADM, Decatur IL) | |
| Shortening | 15 |
| Dry yeast | 5.5 |
| Reduced carb mix 113- | 240 |
| 675 ™ (ADM Arkady, Olathe KS) | |

TABLE 16
Content of 55-gram serving

| | |
|---|---|
| Total | 18.7 g |
| carb | |
| Fiber | 6.8 g |
| Protein | 9.1 g |
| Fat | 1.2 g |

### EXAMPLE 22

### Low Carbohydrate Bagel

Dough was prepared by combining the ingredients shown in Table 17 according to the method described in Example 12. The formulae yielded 13.8 net carbs (Table 17A) and 11.90 net carbs (Table 17B) for the bagels.

TABLE 17

| | A | | B | |
|---|---|---|---|---|
| | | True | | True |
| Ingredients | Grams | Percentage | Grams | Percentage |
| High gluten flour | 300 | 25.72 | 250 | 20.72 |
| Water | 520 | 44.6 | 560 | 46.43 |
| Bagel base 113- | 35 | 3 | 35 | 2.90 |
| 223 ™ (ADM, | | | | |
| Decatur, IL) | | | | |
| Shortening | 15 | 1.28 | 15 | 1.25 |
| Dry yeast | 6 | .51 | 6 | .49 |
| Reduced carb mix | 240 | 20.58 | 290 | 24.04 |
| 113-675 ™ (ADM | | | | |
| Arkady, Olathe, KS) | | | | |
| ProFam 825 ™ | 50 | 4.28 | 50 | 4.14 |
| (ADM, Keokuk, IA) | | | | |

### EXAMPLE 23

### Low Carbohydrate Multigrain Buns

Dough was prepared using the straight dough method by combining the ingredients shown in Table 18. The dough was prepared as described in Example 7.

TABLE 18

| | Baker's |
|---|---|
| Ingredients | Percent |
| White flour | 40 |
| Multigrain Flour | 60 |
| Water | 180 |
| Dry yeast | 3 |
| Yeast food | .5 |
| Gluten | 16 |
| Shortening | 10 |
| Reduced carb mix | 80 |
| 113-675 ™(ADM | |
| Arkady, Olathe, KS) | |
| High fructose corn | 7 |
| syrup | |
| Molasses | 3 |
| Honey | 3 |
| Salt | 4 |

### EXAMPLE 24

### Low Carbohydrate Mix Reducer

A reduced carbohydrate flour substitute, also referred to herein as “additive”, was prepared by standard blending methods. As a first step, a pre-mix was prepared including the ingredients as shown in Example 19, Table 13 (percentages are weight percentages of the final flour substitute) to be added to formulae for bread and bread products. The pre-mix was tested at 3% (Table 19A) and 2% (Table 19B) of the complete mix as shown in Table 19A and 19B, versus a control without the mix reducer prepared according to the following procedure:
1. Mix 1 minute low and 7 minutes high speed.
2. Dough temp 27° C.
3. Proof: 55 minutes.
4. Bake at 218° C. for 30 minutes.

The results showed that the mix reducer effectively relaxed the dough when added at 2% and 3%. The effect on volume is shown in Table 20 and demonstrated that the volume was as good as or better than control formula.

TABLE 19

| | A | B | Control |
|---|---|---|---|
| Ingredients | Grams | Grams | Grams |
| ADM low mix carb mix | 500 | 500 | 500 |
| 113-611 (ADM | | | |
| Arkady, Olathe, KS) | | | |
| Water | 485 | 485 | 485 |
| Dry yeast | 9 | 9 | 9 |
| Low carb mix reducer | 15 | — | — |
| (Table 14) | | | |
| Low carb mix reducer | — | 10 | — |
| (Table 14) | | | |

TABLE 20

| Volume | Control | A (3%) | B (2%) |
|---|---|---|---|
| 1^{nd} test volume | 3.91 cc/g | — | 4.02 cc/g |
| 2^{nd} test volume | 4.48 cc/g | 4.43 cc/g | — |

### EXAMPLE 25

### Low Carbohydrate Tortillas with Fiber

Dough was prepared by combining the ingredients shown in Table 21. The dough was prepared according method as described in Example 13.

TABLE 21

| | A | B | C |
|---|---|---|---|
| Ingredients | Grams | Grams | Grams |
| Wheat starch (Aytex P ® | 200 | 200 | 200 |
| ADM Arkady, Olathe, KS) | | | |
| Water | 330 | 300 | 320 |
| Gluten 82 ™ (ADM, | 80 | 80 | 90 |
| Candiac, Canada) | | | |
| Alpha cellulose fiber | 65 | — | — |
| Prolite 100 ™ (ADM, | 50 | 50 | 40 |
| Keokuk, IA) | | | |
| AZ Tortilla Base 113- | 28 | 28 | 28 |
| 617 ™ (ADM Arkady, | | | |
| Olathe, KS) | | | |
| Tortilla shortening | 40 | 40 | 40 |
| Fibersol 2 (Matsutani | 35 | 35 | 35 |
| America, Decatur, IL) | | | |
| Wheat fiber (Vitacell | — | 65 | 65 |
| WF600-30 ® JRS, | | | |
| Rosenberg, Germany) | | | |

### EXAMPLE 26

### Low Carbohydrate Multigrain and Honey Wheat Buns

Dough was prepared by combining the ingredients shown in Table 22A and 22B. The dough was prepared according to the method as described in Example 7. Buns produced from this mix had 4.35 net carbs (Table 22A) and 6.5 net carbs (Table 22B) in 39 gram buns.

TABLE 22A
A

| Sponge | | Dough |
|---|---|---|
| Baker's | | Baker's |
| Percent | Ingredients | Percent |
| 75 | Whole wheat flour | 25 |
| 50 | Multigrain Mix 113-633 ™ (ADM | — |
| | Arkady, Olathe KS) | |
| 3.75 | 2xMLO ® (ADM, Arkady, Olathe | — |
| | KS) | |
| 14 | Dry yeast | 1 |
| 1.88 | Yeast food | — |
| 40 | Gluten | — |
| 197 | Water | 360 |
| | Sugar | 15 |
| 25 | Shortening | — |
| — | Salt | 11 |
| — | Calcium propionate | 1.57 |
| — | Molasses | 7.5 |
| | Low Carb Mix 113-675 ™ (ADM | 200 |
| | Arkady, Olathe KS) | |
| | Splenda ™ | .069 |

TABLE 22B
B

| Sponge | | Dough |
|---|---|---|
| Baker's | | Baker's |
| Percent | Ingredients | Percent |
| 75 | Whole wheat flour | 25 |
| 150 | Multigrain Mix 113- | — |
| | 633 ™ (ADM Arkady, | |
| | Olathe KS) | |
| 3.75 | 2xMLO ® (ADM, | — |
| | Arkady, Olathe KS) | |
| 14 | Dry yeast | 1 |
| 40 | Gluten | |
| 197 | Water | 295 |
| 1.88 | Yeast Food | |
| — | Sugar | 20 |
| — | Salt | 11 |
| — | Calcium propionate | 1.57 |
| — | Molasses | 1.5 |
| — | Low Carb Mix 113- | 200 |
| | 675 ™ (ADM Arkady, | |
| | Olathe KS) | |

### EXAMPLE 27

### Low Carbohydrate Tortillas

Dough was prepared by combining the ingredients shown in Table 23. The dough was prepared according the method described in Example 13. Tortillas produced from this mix had 12 net carbs for a 10 g tortilla.

TABLE 23

| | C |
|---|---|
| | Baker's |
| Ingredients | Percent |
| Whole wheat flour | 100 |
| Bread flour | — |
| Soybean oil | 50 |
| Water | 325 |
| Guar gum | 6 |
| Mono & diglycerides | 1 |
| Oat fiber (Vitacell ®, JRS, Rosenberg, | 50 |
| Germany) | |
| Flax flour | 10 |
| Prolite 100 ® (ADM, Keokuk IA) | 30 |
| Gluten | 50 |
| Profam 825 ™ (ADM, Keokuk, IA) | 50 |
| A-Z tortilla base ™ (ADM, Decatur IL) | 25 |
| Fibersol 2 (Matsutani America, Decatur IL) | 40 |

### EXAMPLE 28

### Low Carbohydrate Tortillas

Dough was prepared by combining the ingredients shown in Table 24 to yield a dry mix at 100%; water at 93%, and shortening at 13.54%. The dough was prepared according the method described in Example 13.
1. Mix 1 minute low and 7 minutes high speed
2. Rest time: 15 minutes.
3. Pressed 72 times

Tortillas produced from this mix had 12 net carbs for a 100 g tortilla.

TABLE 24

| | A | B | C | D |
|---|---|---|---|---|
| Ingredients | Grams | Grams | Grams | Grams |
| Wheat starch | 50 | 50 | — | — |
| Water | 425 | 440 | 445 | 445 |
| Gluten 82 (ADM, | 90 | 90 | 90 | 90 |
| Candiac, Canada) | | | | |
| Oat fiber (Vitacell ®, | 80 | 80 | 80 | 80 |
| JRS, Rosenberg, | | | | |
| Germany) | | | | |
| Prolite 100 ® (ADM, | 60 | 60 | 60 | 60 |
| Keokuk IA) | | | | |
| A-Z tortilla base ™ | 24 | 24 | 24 | 24 |
| ADM, Decatur IL) | | | | |
| Shortening | 65 | 65 | 65 | 65 |
| Fibersol 2 ™ | 45 | 45 | 45 | 45 |
| (Matsutani America, | | | | |
| Decatur IL) | | | | |
| Wheat flour | 80 | 80 | 80 | 130 |
| Guar gum | 6 | 6 | 4 | 4 |
| Flax flour | 15 | 15 | 15 | 15 |
| Profam 825 ™ (ADM, | 30 | 30 | 30 | 30 |
| Keokuk, IA) | | | | |
| Xanathan gum | — | — | 2 | 2 |
| (ADM-80 mesh, | | | | |
| ADM, Decatur IL) | | | | |

### EXAMPLE 29

### Low Carbohydrate Tortillas

Dough was prepared by combining the ingredients shown in Table 25 to yield a dry mix at 100%; water at 93%, and shortening at 13.54%. The dough was prepared according the following procedure:
1. Cream dry ingredients and shortening 3-5 minutes on low.
2. Add water and mix dough on slow speed. Temperature of dough should be 32° C.-38° C.
3. Scaling: 57 g ball.
4. Rest time: 15 minutes.
5. Press and cook for 45-60 seconds.

Tortillas produced from this mix had 8.9 grams net carbs per 32 gram serving. The tortillas had a dietary content as shown in Table 26 and contained the ingredients: water, wheat starch, gluten, alpha cellulose fiber, gluten isolate, shortening, and maltodextrin, while the following were 2% or less: salt, baking powder, fumaric acid, calcium propionate, corn starch, sodium steroylaclylate, mono & digliceride, guar gum, yeast, soybean oil, and L-cysteine.

TABLE 25

| | True | |
|---|---|---|
| Ingredients | percent | Grams |
| Wheat starch (Aytex P ® ADM Arkady, Olathe | 24.15 | 200 |
| KS) | | |
| Water | 39.85 | 330 |
| ADM WHETPRO 80 Vital Wheat Gluten ® | 9.66 | 80 |
| (ADM Arkady, Olathe KS) | | |
| Alpha cellulose fiber | 7.85 | 65 |
| Prolite 100 ® (ADM, Keokuk IA) | 6.03 | 50 |
| AZ tortilla base 113-617 ™ (ADM Arkady, | 3.38 | 28 |
| Olathe KS) | | |
| Tortilla shortening (Golden Chef ® ADM, | 4.83 | 40 |
| Decatur IL) | | |
| Fibersol 2 ™ (Matsutani America, Decatur IL) | 4.22 | 35 |
| Guar Gum | | 5 |

TABLE 26

| | Calories from Fat |
|---|---|
| | 20 |
| Calories | % Daily |
| 100 | Value* |
| Total Fat 2.2 g | 4% |
| Saturated Fat 0.5 g | 0% |
| Cholesterol 0 mg | 0% |
| Sodium 340 mg | 14% |
| Total Carbohydrate | 4% |
| 13.5 g | |
| Dietary Fiber 4.6 g | 13% |
| Sugars 0 g | |
| Protein 4.6 g | |
| Vitamin A | 0% |
| Vitamin C | 0% |
| Calcium | 4% |
| Iron | 8% |

*Percent Daily Values based on a 2,000 calorie diet. Individual daily values may vary.

### EXAMPLE 30

### Low Carbohydrate Bread and Buns

Dough was prepared by combining the ingredients shown in Table 27. The dough was prepared according the following method:

Sponge Procedure:

1. Mix two minutes low speed; seven minutes high speed.
2. Dough temperature 24°-26° C.
3. Fermentation 23-25° C. and 80% RH for three to four hours.
   Dough Procedure
1. Mix to gluten development.
2. Dough temperature 27° C.
3. Floor time 5-10 minutes.
4. Shape and pan, 64 g
5. Proof: 41-43° C. for 60 minutes or less.

6. Bake at 216° C. for 12 minutes.

TABLE 27

| | A | B |
|---|---|---|
| | White | Wheat |
| | bread | bread |
| Ingredients | Grams | Grams |
| Sponge Ingredients | | |
| Flour | 225 | — |
| 2xMLO ® (ADM, | — | 3 |
| Arkady, Olathe KS) | | |
| Whole wheat flour | — | 225 |
| Gluten | 31 | 31 |
| Yeast food | 1.5 | 1.5 |
| Dry yeast | 12 | 13 |
| Shortening | 30 | 30 |
| Water | 180 | 190 |
| Dough Ingredients | | |
| Flour | 75 | — |
| Whole wheat flour | — | 75 |
| Water | 310 | 300 |
| High fructose corn | 35 | 25 |
| syrup | | |
| Salt | 12 | 11 |
| Calcium propionate | 2.5 | 2 |
| Low carb mix | 170 | 170 |
| 113675 ™ (ADM, | | |
| Arkady, Olathe KS) | | |
| Prolite 100 ® (ADM, | 33 | 33 |
| Keokuk IA) | | |
| Honey | — | 15 |

### EXAMPLE 32

### Low Carbohydrate Tortilla

Dough was prepared by combining the ingredients shown in Table 28. The dough was prepared according the procedure as shown in Example 12. Tortillas produced from this mix had 12 net carbs for a 10 g tortilla. The pH from various test runs of the formula yielded: 5.3, 5.34, 5.37, 5.35, 5.26, 5.31, and 5.19.

TABLE 28

| Ingredients | Grams |
|---|---|
| Gluten 82 ™ (ADM, Candiac, Canada) | 90 |
| Oat fiber (Vitacel ™, JRS, Posenberg, | 80 |
| Germany) | |
| Prolite 100 ® (ADM, Keokuk IA) | 60 |
| LS Tortilla Base 113-629 ™ (ADM | 24 |
| Arkady, Olathe, KS) | |
| Shortening | 90 |
| Fibersol 2 ™ (Matsutani America, | 45 |
| Decatur, IL) | |
| Whole wheat flour | 120 |
| Guar gum | 6 |
| Flax flour | 15 |
| Xanatha | 2 |
| Sorbic acid | 2 |
| Profam 825 ™ (ADM, Keokuk, IA) | 30 |
| Water | (465-450) |

It will be appreciated by those skilled in the art that changes could be made to the embodiments described herein without departing from the broad concept of the invention. It is understood, therefore, that this invention is not limited to the particular embodiments disclosed, but is intended to cover modifications that are within the spirit and scope of the invention as defined by the claims.

We claim:

1. A dough additive, comprising:
wheat gluten;
insoluble fiber; and
a dough conditioner comprising an oxidizer and a mix reducer.

2. The dough additive of claim 1, wherein the wheat gluten is at least 75% wt. protein.

3. The dough additive of claim 1, wherein the wheat gluten is at least 80% wt. protein.

4. The dough additive of claim 1, wherein the wheat gluten is 82% wt. protein.

5. The dough additive of claim 1, wherein the insoluble fiber is selected from the group consisting of a cellulose, an alpha cellulose, and an oat fiber.

6. The dough additive of claim 1, comprising from 50% wt. to 70% wt. wheat gluten.

7. The dough additive of claim 6, comprising 60% wt. wheat gluten.

8. The dough additive of claim 1, comprising from 30% wt. to 40% wt. insoluble fiber.

9. The dough additive of claim 8, comprising from 33% wt. to 38% wt. wheat gluten.

10. The dough additive of claim 8, wherein the wheat gluten is present in an amount of 36%.

11. The dough additive of claim 1, further comprising an emulsifier.

12. The dough additive of claim 11, wherein the emulsifier is one or more of sodium stearoyl lactate, monoglycerides, diglycerides, ethoxylated monoglycerides, ethoxylated diglycerides, diacetyl tartate esters of fatty acids, polyoxyethylene monoglycerides succinyl monoglycerides.

13. The dough additive of claim 1, wherein the mix reducer is selected from the group consisting of L-glycine, glutathione, non-leavening yeast, a bisulfite salt, sorbic acid, a protease, and combinations thereof.

14. The dough additive of claim 1, wherein the oxidizer is selected from the group consisting of ascorbic acid, azido-carbamide, potassium bromate, calcium bromate potassium iodate, calcium iodate, and combinations thereof.

15. The dough additive of claim 1, comprising 1% wt. oxidizer.

16. The dough additive of claim 1, comprising from 2.0% wt. to 3.0% wt. mix reducer.

17. A bread dough comprising flour and the additive of claim 1 in an amount ranging from 50 Baker's percent to 150 Baker's percent.

18. A bread dough comprising flour, a leavening agent, water and the additive of claim 1 in an amount ranging from 50 Baker's percent to 150 Baker's percent.

19. The bread dough of claim 18, comprising from 40 Baker's percent to 100 Baker's percent wheat gluten.

20. A bread product prepared from the bread dough of claim 18.

21. A method of preparing a dough comprising mixing flour, a leavening agent, water and the additive of claim 1 in an amount ranging from 50% wt. to 150% wt. of the flour.

22. The method of claim 21, wherein the leavening agent is yeast.

23. The method of claim 21, comprising:
forming a sponge of flour, water and yeast; and
adding to the sponge flour and the additive of claim 1 in an amount ranging from 50% wt. to 150% wt. of the total flour content of the dough.

24. A method of preparing a dough additive comprising combining wheat gluten;
insoluble fiber; and
a dough conditioner comprising an oxidizer and a mix reducer.

25. The method of claim 24, wherein the wheat gluten is at least 80% wt. protein.

26. The method of claim 24, wherein the insoluble fiber is selected from the group consisting of a cellulose, an alpha cellulose, and an oat fiber.
